(19) United States
(12) Patent Application Publication
(10) Pub. No.: US 2007/0104280 A1
(43) Pub. Date: May 10, 2007

(54) Wireless data transmission method, and corresponding signal, system, transmitter and receiver

(75) Inventors: Nicolas Ibrahim, Montigyn Le Bretonneux (FR); Thierry Werling, Le Mans (FR)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Wavecom, Issy-Les-Moulineaux Cedex (FR)

(21) Appl. No.: 10/545,918

(22) PCT Filed: Feb. 13, 2004
(86) PCT No.: PCT/FR04/00344

§ 371 Date: Dec. 7, 2006

(30) Foreign Application Priority Data
Feb. 17, 2003 (FR) 03/01909
Jul. 25, 2003 (FR) 03/09204

(51) Int. Cl. H04K 1/10

(52) U.S. Cl. 375/260

(57) ABSTRACT

A method for the wireless transmission of data between a transmitter and a receiver, involving the use of at least one single-carrier pilot signal and at least one signal for the transmission of data transmitted using a multicarrier modulation. A estimation of the response of the transmission channel of the first signal is produced, the estimation takes account of the single-carrier pilot signal and at least one part of the pilot signal which coincides temporarily with at least one part of said first signal. The invention also relates to the transmitter, the receiver and a corresponding signal.

This invention relates to the telecommunications field, and particularly the invention relates to the transmission and processing of data, particularly in a cell network and particularly at high throughput.

More precisely, the invention relates to a channel response estimate and use of this estimate to equalise data in a received signal.

Third generation and subsequent radiotelephony systems propose or enable many services and applications requiring very high speed broadband data transmission. Resources allocated to data transfers (for example files containing sound and/or fixed or animated images), particularly through the Internet network or similar networks, will occupy an overriding part of the available resource and will probably exceed the resources allocated to voice communications which should remain approximately constant.

However, the total throughput offered to users of radiotelephony equipment is limited particularly by the available frequency bandwidth. A traditional solution to increase available resources is to increase the density of cells within a given territory. This creates a network infrastructure divided into “micro-cells”, that are relatively small cells. A disadvantage of this technique is that it requires an increase in the number of fixed stations (base stations BS, called Node B according to the UMTS standard) that are relatively complex and expensive elements. Furthermore, although the data throughput is high, it is not optimum. Furthermore, at the higher level, it is clear that as the number of cells and therefore the number of fixed stations increases, management will become more complex.

In radiotelecommunication systems, transmitted signals are usually subject to echoes leading to the presence of multiple paths with different amplitudes and different delays. The combination of these paths may lead to fading at the receiver that can very seriously disturb a reception. Furthermore, since the environment and/or the receiver are mobile, the channel varies with time. Therefore, efficient means are necessary in such systems to compensate for disturbances on signals and particularly to estimate the channel response and to equalise received data taking account of this estimate. This requires the transmission of reference data (particularly pilots). Obviously, these reference data are transmitted at the detriment of useful data, which causes a reduction in the useful throughput. This is particularly the case in third generation Universal Mobile Telecommunication System (UMTS) networks.

Furthermore, like existing radiotelephone systems, the third generation systems under development are based on a symmetric structure. Thus, the UMTS standard defined in the 3GPP (Third Generation Partnership Project), defines a symmetric distribution between the downlink (base station to terminal) and the uplink (terminal to base station) for the main FDD (Frequency Division Duplex) link. There is also a TDD (Time Division Duplex) link that enables some asymmetry. However, the asymmetry thus offered is limited faced with the user needs for broadband Internet type services, with or without mobility, on the downlink.

It is also planned to add a high speed downlink packet access (HSDPA) link that provides an additional throughput in order to satisfy the increased needs in terms of throughput, particularly for multimedia applications. This link is based on packet data transmission using:
either a single-carrier modulation (also called mono-carrier) of the spectrum spreading type (CDMA “Code Division Multiple Access”),
or a multiple-carrier (or sub-carrier) modulation (also called multi-carrier) for example of the OFDM (Orthogonal Frequency Division Multiplex) type.

Therefore, in the second case, a CDMA channel (for the “basic” symmetric link) and an OFDM channel (for an additional data transmission link) will be used jointly, the two channels having to be treated (particularly demodulated and equalised) separately.

A channel estimate is made from pilots inserted in the OFDM signal so as to enable equalisation of the received signal, and to correctly decode data received on an OFDM channel, particularly in a noisy environment introducing multiple echoes of the radio signal.

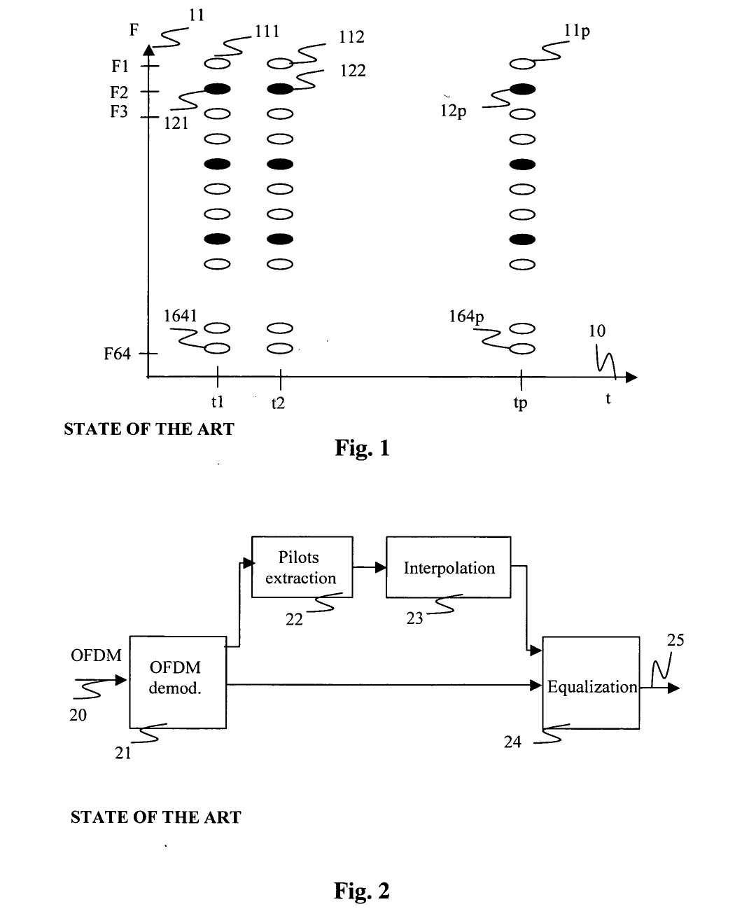

The principle of the OFDM (shown with reference to FIGS. 1 and 2) consists of dividing a frequency band into a sufficiently large number of sub-pass bands such that a channel carrying multiple paths and therefore selective in frequency becomes non-selective in each sub-band. The channel then becomes multiplicative on each sub-band, which facilitates equalisation and efficiently reduces selectivity of the propagation channel.

FIG. 1 shows an OFDM signal known in itself in a time/frequency plane. This signal comprises a sequence of OFDM symbols 1641 to 164p corresponding to times t1 to tp respectively. Each of the OFDM symbols 1641 to 164p comprises several sub-carriers symbolised by full or empty ellipses, each associated with a frequency. Thus, the symbol 1641 comprises a first sub-carrier 111 associated with frequency F1, a second sub-carrier associated with a frequency F2 and so on until the 64th sub-carrier associated with a frequency F64. Some frequencies (the corresponding sub-carriers being represented in the form of full ellipses) are reserved to transmit a pilot while others are reserved to transport data (the corresponding sub-carriers being represented in the form of empty ellipses). Thus for example, the sub-carriers 111, 112, 11p associated with the frequency F1 are used to transport data while sub-carriers 121, 122, 12p associated with the frequency F2 are used as pilots.

FIG. 2 shows processing (known in itself) of a signal 20 comprising OFDM symbols 1641 to 164p presented with reference to FIG. 1.

The signal 20 is firstly presented in base band to a demodulator 21 that converts the received signal into a series of samples that will be processed afterwards. The OFDM signal 20 comprises a sum of several symbols each modulating a sub-carrier for a duration corresponding to an OFDM symbol. Since the sub-carriers are orthogonal to each other, the OFDM demodulator 21 projects the received signal onto all sub-carriers, so that information symbols can thus be extracted.

The demodulator 20 then supplies pilot symbol extraction means 22 and an equaliser 24.

The means 22 extract pilot symbols from the demodulated OFDM signal to supply channel values at time/frequency positions corresponding to interpolation means 23.

The interpolation means 23 make a channel estimate throughout the time/frequency plane from channel values output by the means 22 and supply the equaliser 24 with the channel estimate thus obtained.

The equaliser 24 equalises information symbols transmitted by the demodulator 21 from the channel estimate provided by the means 23, outputting a sequence of equalised information 25.

The equalisation processing of a CDMA signal is fairly different from that described above for a signal corresponding to a multiple-carrier modulation.

An auto-correlation of a dedicated continuously transmitted pilot signal (called the CPICH channel) can be made to equalise a CDMA signal within the context of the UMTS standard and more generally to equalise a single-carrier signal using a multiple-path channel. A multiple-path channel includes several paths each affected by a delay and an attenuation.

Thus, after determination of the delays τᵢ suffered by the transmitted pilot signal, this signal is auto-correlated. The transmission channel comprising L paths may be modeled in the form of the following transfer function h(t):

$$h ( t ) = {\sum }_{i = 0}^{L - 1} {a}_{i} ( t ) δ ( t - {τ}_{i} )$$

where
aᵢ(t) represents a channel coefficient along the ith path;
τᵢ is a delay associated with the ith path;
t is the time; and
δ is the Dirac distribution.

The main purpose of the invention is to overcome these disadvantages according to prior art.

More precisely, one purpose of the invention is to provide a method and devices for transmission of data through a radio channel (that could therefore be a multiple-path channel) that are technically relatively easy to implement and therefore not very expensive, and adapted to the reception of different types of data (for example voice data and low speed or high speed media data).

Another purpose of the invention is to propose such a data transmission technique improving the use of available resources and that is particularly suitable for the transmission of data at low or high speeds (for example several Mbits/s).

Another purpose of the invention is to improve the use of an allocated frequency band while maintaining a reliable and efficient data transmission.

Another purpose of the invention is to provide such a technique enabling data reception (particularly at high throughput) even under unfavourable reception conditions (particularly high displacement speed and multiple paths).

Yet another purpose of the invention is to provide such a technique that enables an improved allocation of the transmission resource between one or several mobiles at a given instant. In particular, one purpose of the invention is to share the broadband transmission resource.

Another purpose of the invention is to improve the robustness towards radio mobile propagation conditions and particularly to improve data transmission performances and/or mobility of communication terminals.

To achieve this, the invention proposes a method for radio data transmission between a transmitter and a receiver using at least one single-carrier pilot signal and at least one first transmission signal for data transmitted using a multiple-carrier modulation, remarkable in that it comprises a step to estimate the response of the transmission channel for the first transmission signal for data transmitted using a multiple-carrier modulation, the estimate taking account of the single-carrier pilot signal, at least part of the pilot signal being coincident in time with at least part of the first signal.

In particular, a pilot signal is a predetermined signal for which some time, frequency and/or amplitude characteristics during the transmission are known to the receiver, which is used to estimate a transmission channel.

For the purposes of this description, stating that at least part of the said pilot signal coincides in time with at least part of the first signal, means that all or part of the pilot signal coincides in time with all or part of the first signal.

According to a one particular characteristic, the method is remarkable in that the part of the pilot signal taken into account by the estimate coincides entirely with at least part of the first signal.

This results in a better estimate of the response of the transmission channel for the first signal.

According to one particular characteristic, the method is remarkable in that the pilot signal and the first signal are asynchronous.

In this way, the method is easy to use since its constraints are less severe.

According to one particular characteristic, the method is remarkable in that the pilot signal and the first signal are synchronous.

Thus, the estimate of the response of the channel for the first signal is direct and there is no need to extrapolate the rate of the first signal and the pilot signal.

According to one particular characteristic, the method is remarkable in that the frequency band used for the pilot signal on a transmission channel encompasses the frequency band used for the first transmission signal.

Thus, the entire frequency band used for the first transmission signal based on a multiple-carrier modulation, used particularly to obtain a precise estimate of the channel over the entire band, is used for the equalization. If the frequency band used for the said pilot signal on a transmission channel does not entirely encompass the frequency band used for the first transmission signal, extrapolation is necessary to obtain information about the entire band corresponding to the first multiple-carrier transmission signal, this extrapolation giving less reliable results than an estimate on the entire band.

According to one particular characteristic, the method is remarkable in that it includes equalization of data transmitted according to a multiple-carrier modulation, equalisation taking account of the estimated response of the transmission channel used for the first transmission signal.

Thus, use of equalisation of the first signal does not require the use of pilots inserted in the multiple-carrier signal, which saves on the pass band.

According to one particular characteristic, the method is remarkable in that the estimate takes account of at least one auto-correlation made on the pilot signal.

According to one particular characteristic, the method is remarkable in that each of the auto-correlations is associated with a delay corresponding to a path on the transmission channel.

According to one particular characteristic, the method is remarkable in that the auto-correlations are made for each path between the transmitter and the receiver on the transmission channel and corresponding to delays of less than a determined maximum limit.

Thus, the entire transmission channel can be estimated accurately and there is no need to determine echoes.

According to one particular characteristic, the method is remarkable in that it includes a step to select paths between the transmitter and the receiver on the transmission channel, and in that the auto-correlations are made for each path selected during the selection step.

Thus, use of the method is simplified, which is useful in particular to save hardware resources (electronic components, silicon surface area or CPU time) and/or energy (particularly since it is power supplied by a battery with limited endurance in the case of mobile terminals).

In a single-carrier mobile system, paths are usually selected based on echo determination. Thus, this step does not consume any additional resources.

According to one particular characteristic, the method is remarkable in that it includes a step to determine a frequency response taking account of auto-correlations.

Thus, a time and frequency channel estimate may be supplied, which is particularly well adapted to equalisation of data transmitted on a multiple-carrier signal.

According to one particular characteristic, the method is remarkable in that it includes a Fourier transform step supplying at least one coefficient associated with each sub-carrier of a symbol of the first transmission signal for data transmitted using a multiple-carrier modulation.

According to one particular characteristic, the method is remarkable in that the pilot signal is of the spectrum spreading type.

Thus, the invention enables compatibility with spectrum spreading systems (particularly of the UMTS type), since elements dedicated to processing of spread spectrum signals can advantageously be used for equalisation of data transmitted on a multiple-carrier channel.

Furthermore, the use of the data transmission method is simplified because there is no need to manage two independent transmission channels (insertion of pilots, channel estimate, etc.); only the single-carrier channel comprises pilots.

According to one particular characteristic, the method is remarkable in that the first transmission signal for data transmitted using a multiple-carrier modulation does not include a pilot symbol.

Thus, the method enables a saving of the pass band, and particularly an improvement in the global transmission rate (or useful data throughput).

It also enables an improvement of energy allocated to information symbols for a given maximum transmission power.

The fluctuation of the multiple-carrier signal envelope is also reduced.

According to one particular characteristic, the method is remarkable in that the first transmission signal is of the OFDM type.

According to one particular characteristic, the method is remarkable in that the first transmission signal is of the IOTA type.

The use of the method when the multiple-carrier signal is of the IOTA type is particularly advantageous since a first crown type processing intended to eliminate interference of pilots in the IOTA multiple-carrier signal is not used in this case. Thus, the invention can take advantage of the IOTA modulation (particularly the lack of a guard interval thus increasing the data transmission speed), while being easy to implement.

It should be noted that the IOTA (Isotropic Orthogonal Transform Algorithm) type modulation is defined in patent FR-95 05455 filed on May 2 1995. The IOTA modulation is based particularly on a multi-carrier signal that will be transmitted to a digital receiver corresponding to frequency multiplexing of several elementary sub-carriers each corresponding to a series of symbols, two consecutive symbols being separated by a symbol time τ₀, the spacing ν₀ between two adjacent sub-carriers being equal to half the inverse of the symbol time τ₀ and each sub-carrier being subjected to shaping filtering of its spectrum with a bandwidth greater than twice the spacing between sub-carriers ν₀, the filtering being chosen such that each symbol is strongly concentrated in the time domain and in the frequency domain.

According to one particular characteristic, the method is remarkable in that the transmitter also transmits a second data transmission signal to the receiver on a single-carrier channel, the signal being equalised from a channel estimate determined as a function of the pilot signal.

Thus, a single-carrier channel can be used for transmission of information data and/or signalling data, the channel estimate from the single-carrier pilot signal equalising data transmitted on a single-carrier signal and also data transmitted on a multiple-carrier signal. Therefore, the invention enables a wide variety of applications, particularly data transmission, for example at low speed on a single-carrier channel and at high speed on a multiple-carrier channel, and compatibility with existing radio communication standards (particularly the UMTS standard and more generally mobile network standards based on the use of single-carrier channels).

According to one particular characteristic, the method is remarkable in that the transmitter and the receiver belong to a mobile communication network.

Thus, the method is particularly well suited to transmission conditions towards mobile terminals and/or in a mobile environment. In particular, it makes it possible to use an unstable channel with multiple echoes.

It is also particularly suitable for the use of a communication between a base station and a terminal. In particular, one advantageous embodiment comprises two downlink channels between a base station and a terminal, one of the channels being of the single-carrier with pilot type and the other being of the multiple-carrier without pilot type.

According to one particular characteristic, the method is remarkable in that the transmitter belongs to a base station in the mobile communication network and the receiver belongs to a terminal, the base station sending the pilot signal and the first data transmission signal using a multiple-carrier and high speed modulation whenever necessary.

Thus, the method is particularly well suited to transmission between a base station and a terminal in the mobile network, and more precisely but not exclusively, to high speed transmission (particularly for data transmissions at a speed greater than 1 Mbits/s) on a downlink between the base station and the terminal using a multiple-carrier modulation. In this context, a two-directional link can be provided between the base station and the terminal:
the base station transmitting data on a multiple-carrier channel and a pilot signal and possibly signalling and/or information data at low speed on a single-carrier channel,
the terminal transmitting signalling and/or information data to the base station on a single-carrier channel.

According to one particular characteristic, the method is remarkable in that it comprises a step to generate a reference clock associated with the first transmission signal for data transmitted using a multiple-carrier modulation, the generation of a reference clock taking account of the single-carrier pilot signal, and the reference clock outputting the estimate of the response of the transmission channel for the first transmission signal for data transmitted using a multiple-carrier modulation.

According to one particular characteristic, the method is remarkable in that it comprises equalisation of data transmitted using a multiple-carrier modulation, the first transmission signal for data transmitted using a multiple-carrier modulation comprising pilot symbols and the reference clock outputting the equalisation.

Thus, in particular, there is no point in reserving OFDM symbols that contain only pilots if the transmission channel is very noisy and/or disturbed. Therefore the useful pass band corresponding to the multiple-carrier modulation is optimised, the reference clock and/or frequency slaving of the receiver on the transmitter being determined taking account of the single-carrier pilot signal.

According to one particular characteristic, the method is remarkable in that it uses at least two transmission modes for data transmitted using a multiple-carrier modulation, the first transmission signal for data transmitted using a multiple-carrier modulation comprising pilot symbols according to a first mode and not including pilot symbols according to a second mode.

According to one particular characteristic, the method is remarkable in that it comprises a step to change over from the first mode to the second mode and vice versa as a function of the reception quality of the first transmission signal for data transmitted using a multiple-carrier modulation.

Thus, use of the pass band and the useful throughput associated with the communication are optimised while enabling a good transmission quality; a communication mode without pilot is preferred on the multiple-carrier signal when the reception quality is sufficient; on the other hand, a communication mode with pilot on the single-carrier signal and on the multiple-carrier signal is used if the reception quality without pilot on the multiple-carrier signal is not sufficient and the number of pilots is increased or reduced as a function of the reception quality.

The invention also relates to a radio data reception device using at least one single-carrier pilot signal and at least one transmission signal for data transmitted using a multiple-carrier modulation, remarkable in that the device comprises means for estimating the response of the transmission channel for the transmission signal for data transmitted using a multiple-carrier modulation, the estimate taking account of the single-carrier pilot signal, at least part of the pilot signal being coincident in time with at least part of the first signal.

The invention also relates to a radio data transmission device using at least one single-carrier pilot signal and at least one transmission signal for data transmitted using a multiple-carrier modulation, remarkable in that the device comprises means of modulating the transmission signal without pilot, the pilot signal being designed to enable an estimate of the response of the transmission channel for the transmission signal for data transmitted using a multiple-carrier modulation, the estimate taking account of the single-carrier pilot signal, at least part of the pilot signal being coincident in time with at least part of the first signal.

The invention also relates to a radio transmission signal comprising at least one single-carrier pilot channel and a multiple-carrier data transmission channel, remarkable in that the multiple-carrier transmission channel has no pilot, the single-carrier pilot channel being intended to enable an estimate of the response of the transmission channel for data transmitted using a multiple-carrier modulation, the estimate taking account of the single-carrier pilot signal, at least part of the pilot signal being coincident in time with at least part of the first signal.

The invention also relates to a cell type telecommunication system using at least one single-carrier pilot channel and one multiple-carrier data transmission channel, remarkable in that the multiple-carrier data transmission channel has no pilot, the single-carrier pilot channel being intended to enable an estimate of the response of the transmission channel for data transmitted using a multiple-carrier modulation, the estimate taking account of the single-carrier pilot signal, at least part of the pilot signal being coincident in time with at least part of the first signal.

The advantages of the devices, the data transmission signal and the system are the same as the advantages of the data transmission method, therefore they are not described in more detail herein.

Other characteristics and advantages of the invention will become clear after reading the following description of a preferred embodiment given simply as an illustrative and non-limitative example, and the attached drawings among which:

FIG. 1 shows an example of an OFDM signal known in itself;

FIG. 2 shows a block diagram showing equalisation of the OFDM signal according to FIG. 1;

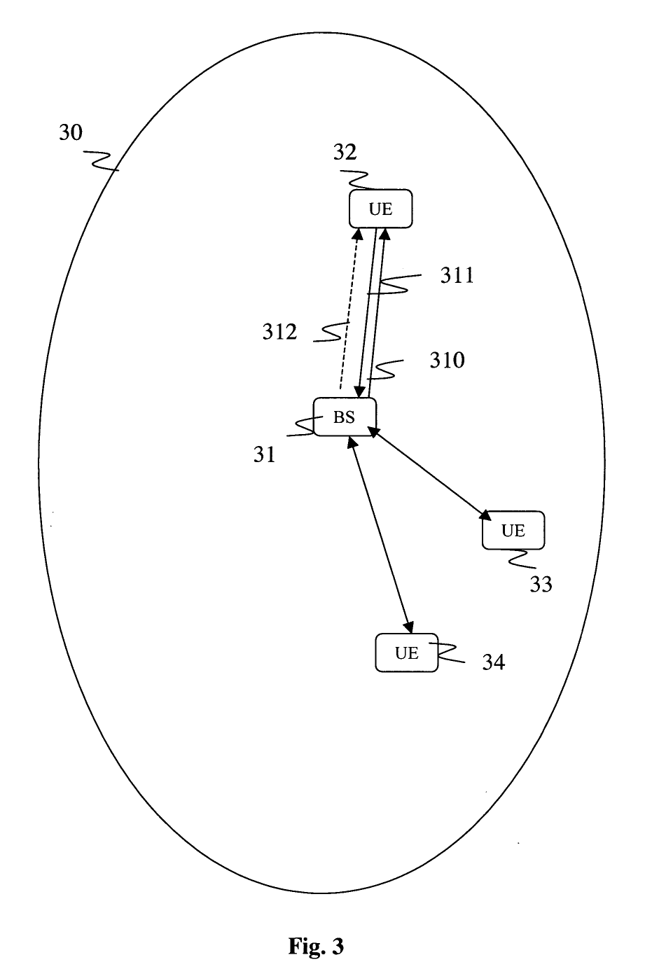

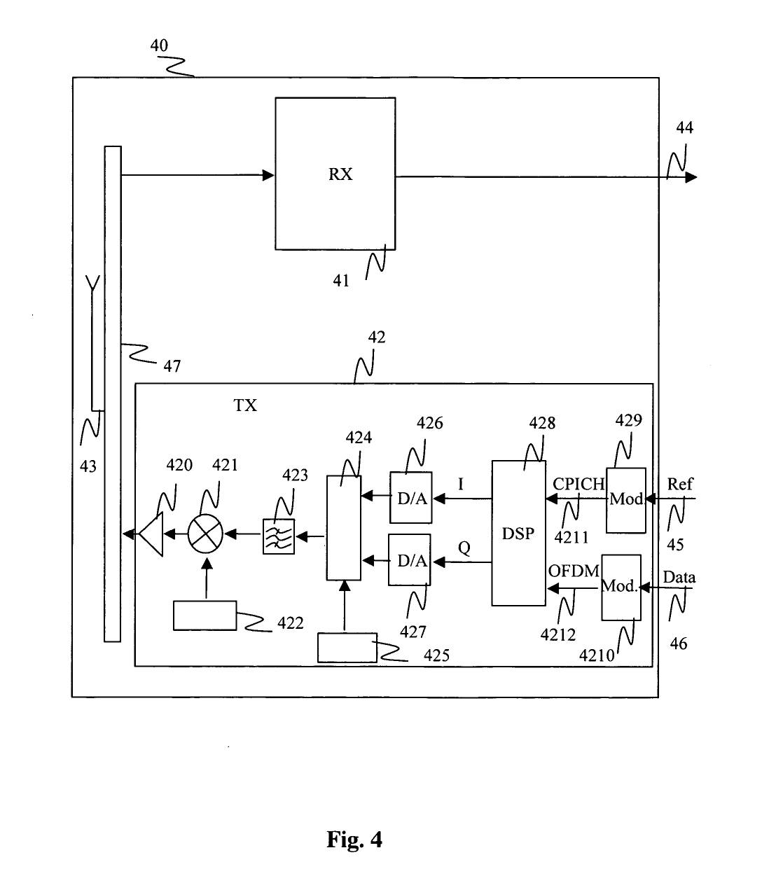

FIG. 3 shows a mobile communication network conforming with the invention according to a particular embodiment;

FIG. 4 describes a transmission-reception module associated with a fixed station used in the network in FIG. 3;

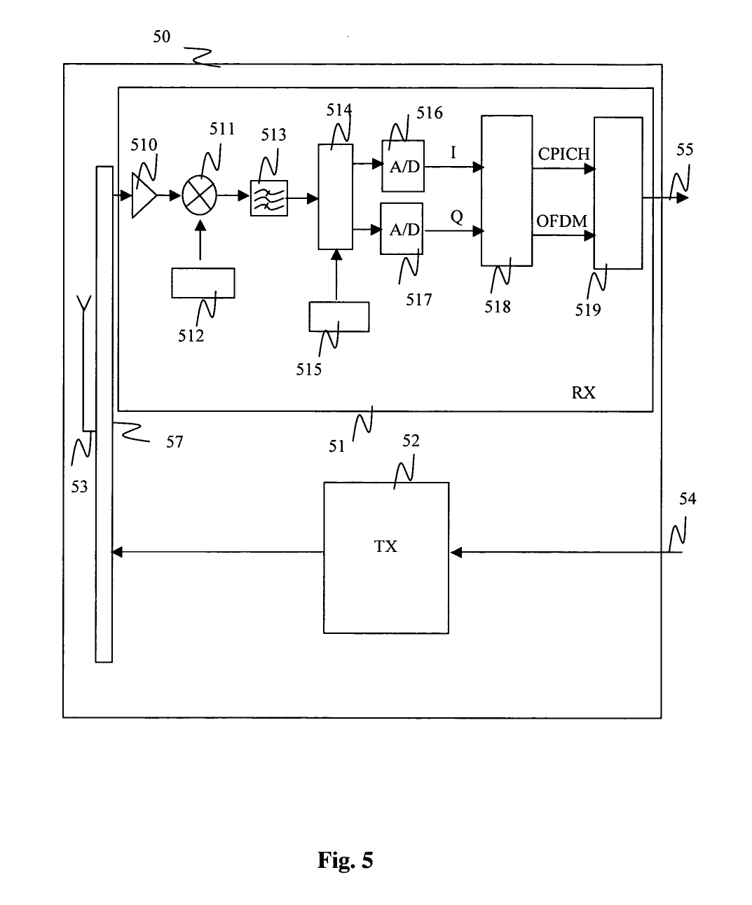

FIG. 5 describes a transmission-reception module associated with a terminal used in the network in FIG. 3;

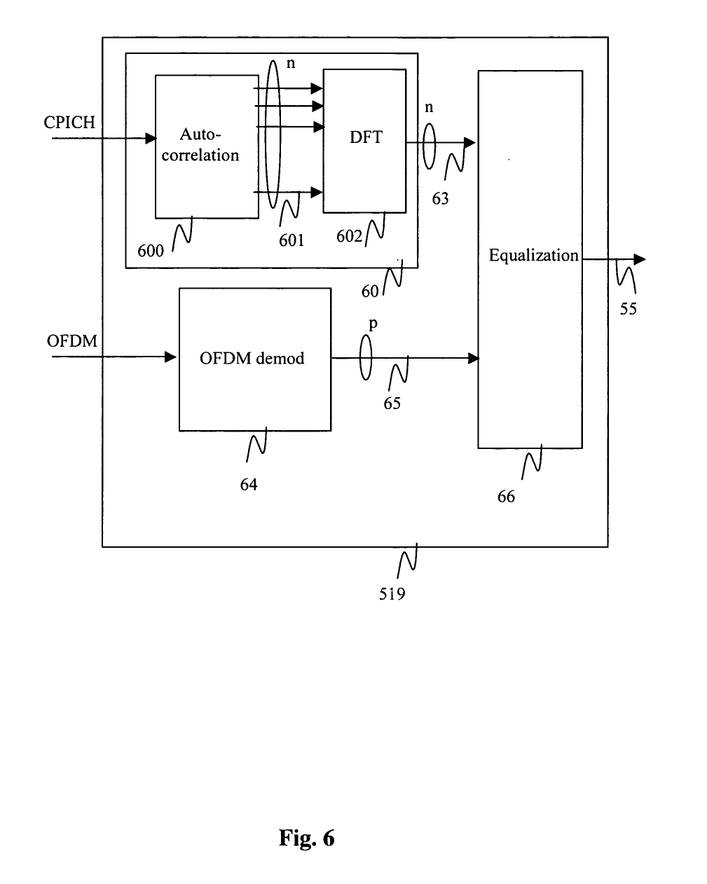

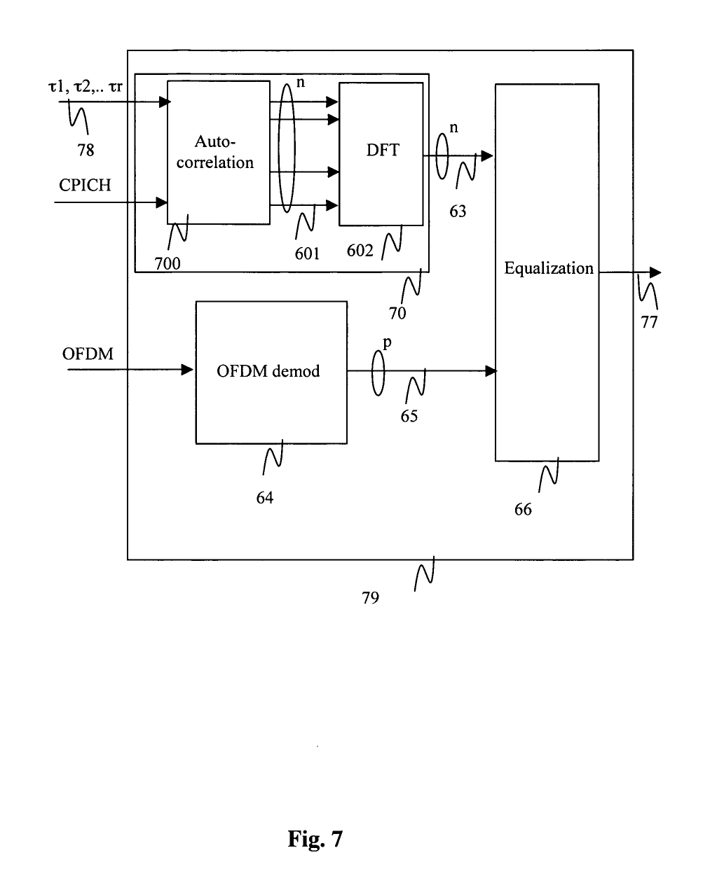

FIG. 6 shows equalisation means used in the transmitter/receiver in FIG. 5;

FIG. 7 shows equalisation means according to a variant of the invention;

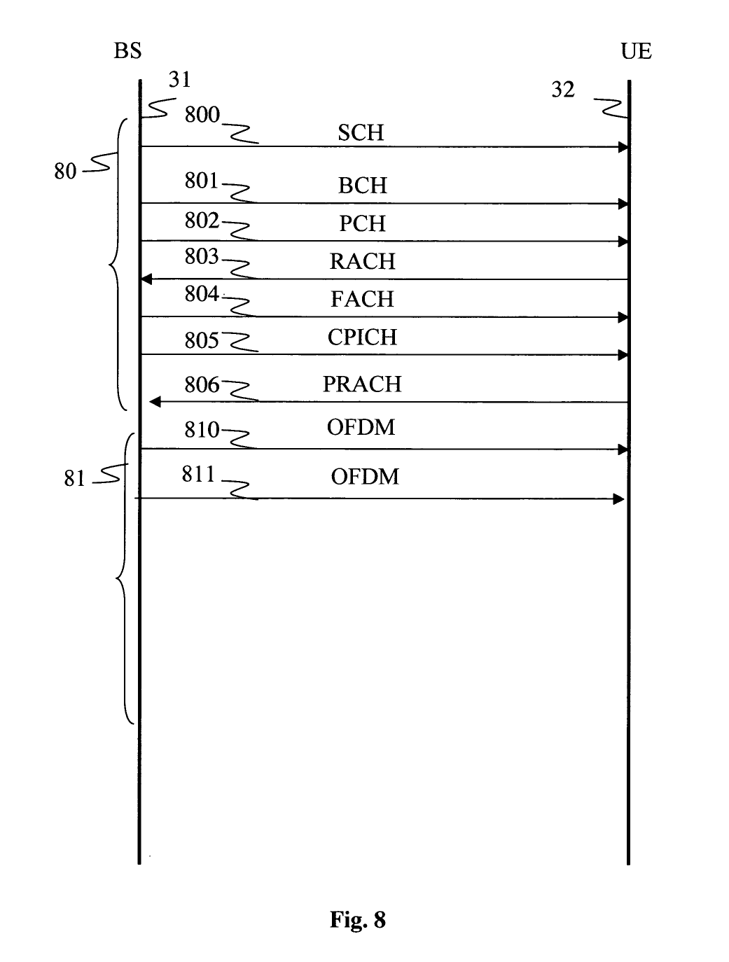

FIG. 8 presents a communication protocol in the mobile communication network in FIG. 3; and

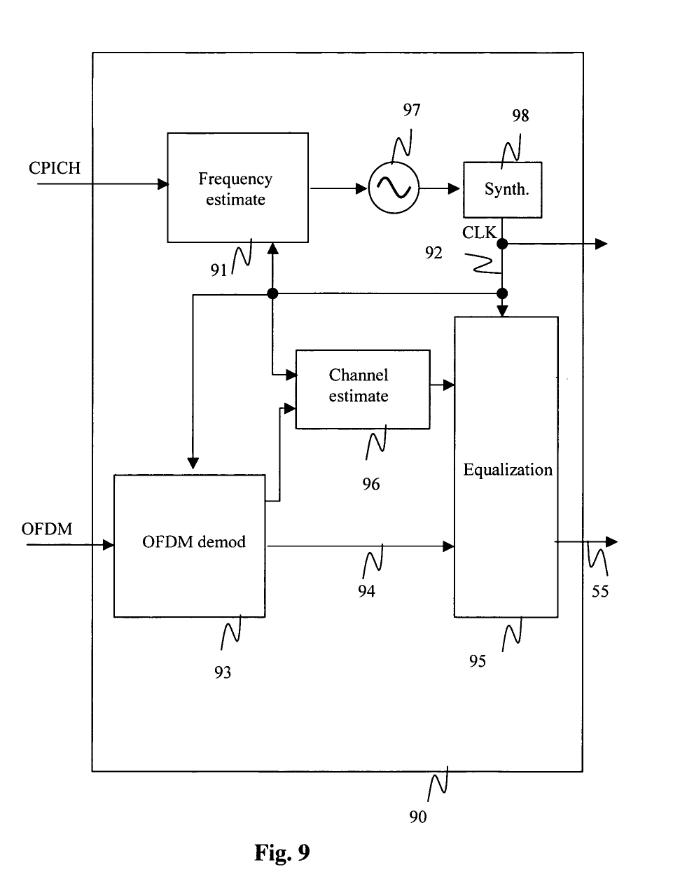

FIG. 9 shows equalisation means used in the transmitter/receiver in FIG. 5 according to one variant embodiment of the invention.

There are several disadvantages with the technique known in itself and shown with reference to FIG. 1, consisting of separately demodulating and equalising a single-carrier channel and a multiple-carrier channel.

In particular, the global transmission speed (or the useful data throughput) is not optimised.

This technique also reduces the energy allocated to information symbols for a given maximum transmission power.

It is also relatively complex to implement, both in transmission and in reception because in particular two independent channels have to be managed.

Furthermore, in the context of an OFDM modulation, an additional envelope fluctuation is generated particularly due to the fact that the energy of the pilot symbols is greater than the energy of the other OFDM symbols and the pilot symbols are distributed discontinuously in the time/frequency plane, which causes an increase in the energy of OFDM symbols containing the pilot symbols.

Another disadvantage of prior art is that additional processing is required when some other types of modulation are used (particularly OFDM/OQAM). In this case, the channel introduces interference between the sub-carriers and it is impossible to obtain a channel estimate directly.

On the other hand, the general principle of the invention is based on the transmission of a single-carrier pilot signal (for example of the CPICH type like that used in the context of the UMTS) associated with data transmission on a multiple-carrier channel (for example of the OFDM type). The channel estimate output by the pilot signal is used to equalise the multiple-carrier channel. The pilot signal is preferably auto-correlated over a length corresponding to the length of an OFDM symbol and this estimate is then transposed in the frequency domain for example by applying a Fourier transform (discrete or fast) to it to supply equalisation of the demodulated OFDM signal.

According to one variant of the invention, the pilot signal is processed in a simplified manner, considering only the most relevant delays.

A block diagram of the mobile radiotelephony network using the invention is presented with reference to FIG. 3.

For example, the network will be partly compatible with the UMTS (Universal Mobile Telecommunication System) standard defined by the 3GPP committee.

The network comprises a cell 30 managed by a base station (BS) 31.

The cell 30 itself comprises the base station 31 and terminals or user equipment (UE) 32, 33 and 34.

The terminals 32, 33 and 34 can exchange data (for an application type layer) and/or signalling data with the base station 31 through uplinks and downlinks. Thus the terminal 32 and the base station 31 are connected in communication through:
a single-carrier downlink 310 enabling transport of signalling and/or communication control data with the terminal 32 and transmission of a pilot signal;
a single-carrier uplink 311 also enabling transport of signalling and/or communication control data; and
a multiple carrier downlink 312 without pilot, for example of the OFDM type, enabling high-speed data transfer from the base station 31 to the terminal 32.

By default, the terminals are in standby mode, in other words in a mode other than communication mode but in which they are present and available for communication. In a first communication mode, these terminals are particularly listening to signals sent by the base station 31 on a downlink using a single-carrier modulation. These signals are transmitted on:
common transport channels corresponding to services offered to high layers in the communication protocol, particularly on BCHs (Broadcast CHannels) and PCHs (Paging CHannels), and
common transport channels corresponding to the physical layer of the communication protocol, particularly on CPICHs (Common Pilot Channels).

Single-carrier channels used by third generation (3G) mobile networks are well know to those skilled in the art of mobile networks and in particular are as specified in the standard entitled “3rd Generation Partnership Project; Technical Specification Group Radio Access Network; Physical Channels and mapping of transport channels onto physical channels (FDD) release 1999” reference 3GPP TS25.21 and distributed by the 3GPP publications office. Therefore these channels will not be described in more detail.

FIG. 4 shows a transmission-reception module 40 belonging to the base station 31 used in the network 30.

The module 40 comprises particularly:
a single or multiple antenna 43;
a duplexer 47;
a reception channel 41; and
a transmission channel 42.

The antenna 43 is connected to each of the reception channels 41 and the transmission channels 42 through the duplexer 47.

The reception channel 41 is designed to process the single-carrier uplink 311 and supplies decoded data received by the antenna 43 on an output 44. This channel 41, for which use is well known to those skilled in the art, will not be described in more detail.

The transmission channel 42 is designed to transmit:
a pilot signal 4211 and signalling and/or communication control data on the single-carrier downlink 310; and
low or high speed data 46 on the multiple-carrier downlink 312.

The transmission channel 42 comprises:
a modulator 429 designed to generate a CPICH pilot signal 4211 starting from a reference code 45;
a modulator 4210 designed to modulate data 46 according to an OFDM multiple-carrier modulation;
a digital signal processor (DSP) 428;
a digital analogue converter 426, 427 on the I channel (channel in phase) and on the Q channel (quadrature phase);
an intermediate frequency modulator 424 controlled by a synthesiser 427;
a pass band filter 423;
a mixer 421 and an agile synthesiser 422 for transposing signals into an intermediate frequency in the transmission band; and
a power amplifier 420.

The DSP 428 is associated with a hardware accelerator for the combination of:
single-carrier signals to be transmitted (including the CPICH pilot channel 4211 and possibly signals carrying control data, signalling data and/or useful information to be transmitted on a single-carrier channel); and

OFDM type multiple-carrier signals 4212 representing useful information 46 to be transmitted.

Unlike the frame shown with reference to FIG. 1, the OFDM channel in this case transports only useful data and does not include sub-carriers associated with pilots.

Furthermore, preferably, the pilot channel 4211 and multiple-carrier signals 4212 are combined synchronously (the OFDM symbols coinciding with CPICH code symbols). According to one variant, the pilot channel 4211 and the multiple-carrier signals 4212 are combined asynchronously.

FIG. 5 shows a transmission-reception module 50 belonging to one of the terminals 32 to 34 used in the network 30. The module 50 is designed to communicate with the module 40 shown with reference to FIG. 4.

The module 50 comprises particularly:
a single or multiple antenna 53;
a duplexer 57;
a reception channel 51; and
a transmission channel 52.

The antenna 53 is connected to the reception channel 51 and to the transmission channel 52 through the duplexer 57.

The transmission channel 52 is designed to process the single-carrier uplink 311. It supplies a single-carrier modulated signal to the antenna 53 for transmission on the uplink 311 from data presented on an input 54. This channel 52, is used in a manner well known to those skilled in the art and will not be described any further.

The reception channel 51 is designed to receive:
a pilot signal and signalling and/or communication control data on the single-carrier downlink 310; and
high-speed data on the multiple-carrier downlink 312.

The reception channel 51 comprises:
a low noise amplifier 510
a mixer 511 and an agile synthesizer 512 designed to transpose the signal received in the transmission band into an intermediate frequency signal;
a pass band filter 423 centred around the intermediate frequency and with a band width corresponding to the width used for transmission of the signal;
a base band I/Q converter 514 controlled by a synthesiser 515;
a digital analogue converter 516, 517 on the I channel (channel in phase) and on the Q channel (quadrature phase);
a digital signal processor (DSP) 518 designed to separate single-carrier signals and multiple-carrier signals; and
equalisation means 519 designed to demodulate and equalise single-carrier signals and multiple-carrier signals output by the DSP 518.

FIG. 6 shows equalisation means 519 that include:
a CPICH input accepting base band signals modulated in single-carrier and output by the DSP 518;
an OFDM input accepting base band signals modulated in multiple carriers (OFDM type) and output by the DSP 518.

The CPICH input includes particularly a CPICH type signal to estimate the transmission channel.

The equalisation means 519 also include:
estimating means 60 designed to estimate a channel from a single-carrier pilot signal;

OFDM demodulation means 64; and
an OFDM equalisation unit 66.

The means 60 accept a CPICH type single-carrier signal as input and include in particular:
auto-correlation means 600; and

Fourier transform means 602.

The auto-correlation means 600 make a channel estimate as a function of the CPICH signal and more precisely an auto-correlation of the CPICH signal for each of the delays τ1 to rn, where τ1 corresponds to the direct path, τ2 to a second path and τn to the longer path (each of the selected paths corresponding to a direct path or a relevant echo). n auto-correlation are thus calculated. In general, τk is equal to the product of a factor k by the chip period Tc of the CPICH code (equal to 1/3840000 s, which is about 0.26 μs in the context of the UMTS standard), where k is preferably an integer or a multiple of 0.5.

The channel coefficient corresponding to a delay τk is obtained using the following auto-correlation equation:

$$h ( {τ}_{k} ) = h ( kTc ) = {\int }_{- ∞}^{+ ∞} CPICH ( r ) \cdot CPICH ( t - kTc ) ⅆ t$$

Considering a CDMA code length equal to 256, and the signal preferably being processed digitally, the sampled version of the auto-correlation equation given above is written as follows:

$$h ( k ) = \frac{1}{256} {\sum }_{i = 0}^{i = 255} CPICH ( i ) \cdot CPICH ( n - i )$$

According to one preferred embodiment of the invention, the OFDM symbols are transmitted synchronously with the CPICH symbols. In this case, the auto-correlation function is used on a window corresponding to a CPICH code symbol (or similarly to an OFDM symbol in the case of synchronisation between the different signals).

According to another embodiment of the invention, the ODFM symbols and the CPICH code symbols are transmitted asynchronously. In this case, several variants may be used:
according to a first variant, auto-correlations of the CPICH symbol closest in time to the OFDM symbol considered are calculated (which enables considerable simplicity of use, since this auto-correlation is usually necessary for other uses in the context of a partly CDMA network);
according to a second variant, auto-correlations are calculated on CPICH symbols that at least partially intersect the OFDM symbol considered and the auto-correlations obtained are interpolated to be input into a channel frequency estimating operation;
according to a third variant (that provides the most reliable channel estimate for a considered OFDM symbol), the auto-correlations are calculated on the end of a first CPICH code and the beginning of a second CPICH code, the selected auto-correlations being synchronously coincident with the OFDM symbol considered.

In all cases, the duration of the proposed correlations is the same as the duration of the OFDM symbol considered.

The auto-correlation means 600 transmit the n results of auto-correlations made to the means 602 on n outputs 601, each of the n results being associated with one of the outputs 601.

The means 602 then make a Fourier transform with length n on the set of n auto-correlation results, thus obtaining the corresponding frequency response. n is chosen to be greater than or equal to the number of sub-carriers used in the OFDM channel. Thus, if each sub-carrier in the OFDM channel uses a 3.75 kHz band, and if each OFDM symbol is modulated on 1024 sub-carriers, the useful band obtained is 3.84 MHz. In this case, the means 602 use a fast Fourier transform (FFT) with a length of 1024 so that 1024 channel coefficients can be obtained on the 3.84 MHz band considered.

As a variant, if the number of OFDM sub-carriers is not a power of 2, the means 602 preferably use a discrete Fourier transform (DFT) with a suitable length. Thus, if each OFDM channel sub-carrier has a band width equal to 3.75 kHz and if each OFDM symbol is modulated on 600 sub-carriers, the result obtained is a useful band of the order of 2 MHz and the means 602 use a DFT with length 600 providing 600 coefficients.

The result obtained is a frequency channel estimate that can be used for the OFDM equalisation. According to one preferred embodiment, the CPICH signal is correlated on the duration of a corresponding OFDM symbol. A new correlation (and therefore a new channel estimate) is thus made for each OFDM symbol. According to one variant, a single estimate may be considered as being valid for several OFDM symbols, particularly when the receiver estimates that the channel is sufficiently stable (which in particular can save resources (CPU time, batteries, etc.) on the receiving terminal).

Simultaneously, the means 64 demodulate the OFDM signal in input and output demodulated OFDM symbols to the OFDM equalisation unit 66.

Receiving the channel estimate and demodulated OFDM symbols communicated by the means 602 and by means 64 respectively at the same time, the equalisation unit equalises the OFDM symbols as a function of the channel estimate and outputs information data corresponding to the OFDM symbols processed. The equalisation may be done using different methods taking account of a channel estimate. A first relatively simple equalisation method includes a multiplication of OFDM symbols received by the channel conjugate (which enables a phase correction). According to another equalisation method, the OFDM symbols are divided by the channel. According to yet another method, the MMSE (Minimum Mean Square Error) type of equalisation of data output from the OFDM symbols is used.

FIG. 7 shows equalisation means 79 according to one variant of the invention that simplifies their use.

The essential difference between the equalisation means 79 and 519 (shown with reference to FIG. 6) is based on the determination of paths associated with an auto-correlation determination. Elements common to the equalisation means 79 and 519 have the same reference and will not be described in more detail.

According to this variant, the receiver uses an echo detection and an estimate of r corresponding delays τ1 to τr (for example starting from a primary synchronisation channel) (“Primary SCH” in the UMTS standard).

The equalisation means 79 include:
estimating means 70 designed to estimate a channel starting from a single-carrier pilot signal;

OFDM demodulation means 64; and
an OFDM equalisation unit 66.

The estimating means 70 accept a single-carrier CPICH type signal as input, and a list of r delays τ1 to τr to be taken into account and in particular comprise:
auto-correlation means 700; and

Fourier transform means 602.

The auto-correlation means 700 make a channel estimate as a function of the CPICH signal and more precisely an auto-correlation of the CPICH signal for each of the delays τ1 to τr to be used (using a method and variants similar to those used in the auto-correlation means 600);

The auto-correlation means 700 transmit the following to the Fourier transform means 602, on n outputs 601:
the r auto-correlation results made corresponding to the delays τ1 to τr; and

(n-r) null auto-correlation values corresponding to the (n-r) delays not selected.

each of the n transmitted values being associated with one of the outputs 601.

According to one variant, the auto-correlation means 700 make a channel estimate as a function of the CPICH signal and more precisely an auto-correlation of the CPICH signal for each of the delays τ1 to τm equal or nearly equal to the delays τ1 to τr. According to this variant, a delay is nearly equal to a delay τi if it is different by not more than P chip periods Tc from the delay τi considered, where P is preferably equal to 2 (but could be other values, for example 1 or 3). Thus, if the delay τi corresponds to an identified echo, an auto-correlation will preferably be made by the means 700 for delays τi−2Tc, τi−Tc, τi, τi+Tc and τi+2Tc. The estimate will be more accurate as the value of P increases. On the other hand, use of the auto-correlation means 700 becomes simpler as the value of P becomes smaller.

According to other variants, the delays used and obtained for example by interpolation of the CPICH signal are non-integer multiples of the chip time Tc.

FIG. 8 shows a communication protocol between the base station 31 and the terminal 32 during a communication using channels 310 to 312. This protocol includes two phases: one phase 80 setting up the communication consisting essentially of signalling data exchanges and a communication phase 81 using a high speed data transmission using an OFDM channel and a CPICH channel for the estimate of the transmission channel.

During the phase 80 in which a communication is set up, the base station 31 sends a signal 800 on the downlink SCH to terminals present in the cell 30 and particularly terminal 32. Thus, the terminal 32 is synchronised on the SCH channel of the base station 31.

It should be noted that the base station 31 transmits this SCH signal regularly and that as soon as synchronisation of the terminal 32 degrades beyond a certain predetermined threshold, it is synchronised on the base station 31 again.

The base station 31 also transmits a signal 801 on the BCH channel. This down signal informs the terminal 32 about which PCH channel it should listen to. Thus, after receiving this signal, the terminal 32 starts listening to the PCH channel indicated by the signal 802.

The base station 31 then sends a signal to the terminal 32 on the PCH channel indicated by the signal 801, this signal being used to detect an incoming call.

Then, assuming that the terminal 32 wants to initialise a communication, it sends a signal 803 on the RACH (Random Access CHannel that is a common channel corresponding to a channel access high layer service), this signal 803 informing the base station 31 that the terminal 32 is requesting that a communication should be set up.

The base station 31 then sends a communication channel allocation signal 804 on the FACH (Fast Access CHannel) that is also a common channel corresponding to a high layer service) using the first communication mode (with single-carrier).

Signals corresponding to the first communication mode are compatible with the first two layers (physical and link) defined by the UMTS standard. According to the invention, at level 3 the base station indicates, where, when and how to listen to the OFDM.

The terminal 32 then starts listening to the CPICH pilot channel 805 that according to the invention is used in particular to estimate the transmission channel. The base station 31 continuously transmits the CPICH pilot channel 805.

The communication is then set up between the terminal 32 and the base station 31.

The mobile sends a request through the PRACH uplink 806 (physical channel corresponding to the RACH channel) while listening to the FACH channel 804 to have the response from the network as specified in the existing UMTS-FDD standard. If the network decides that the volume of information to be transmitted to the mobile is large, and particularly if the throughput available through the FACH channel is not sufficient, the base station 31 informs the terminal 32 through the FACH channel 804 corresponding to the first communication mode that it should listen to the associated OFDM channel for data transmission.

Thus, according to the invention, the use of a common channel called the OFDM channel using an OFDM modulation is coupled with RACH/FACH common channels (in other words the terminal transmits a RACH request and the base station responds with a FACH frame that informs the terminal 32 that the data transmission between the base station 31 and the terminal 32 is made using a second multiple-carrier communication mode) without changing the physical transmission characteristics of the RACH (uplink) and the FACH (downlink).

The FACH channel carries signalling information enabling the mobile to listen to the OFDM channel correctly. The FACH channel indicates when (in other words the moment at which the block intended for the terminal starts and stops), where (in the frequency band, the transmission does not necessarily use the entire available frequency band) and how (coding format, interlacing, etc.) to listen to the OFDM channel to receive the data block concerned. By default, the base station uses an OFDM modulation with predetermined characteristics (symbol times, spacing between sub-carriers and distribution of reference symbols or pilot symbols). According to one variant, the base station will optimise these characteristics dynamically and adapt them as a function of the characteristics of the propagation channel.

Thus, communication between the base station 31 and the terminal 32 switches over into a second communication mode (phase 81) that uses a multiple-carrier modulation without pilot, the transmission of a CPICH single-carrier pilot channel being preferably maintained. Thus, the base station 31 transmits data on the OFDM common channel through successive and subsequent signals 810, 811, the CPICH single-carrier pilot signal being continuously transmitted by the base station 31 so that the terminal 32 can estimate the transmission channel correctly.

The terminal 32 can then send level 2 acknowledgements on the RACH channel.

At the end of the communication, the terminal 32 and/or the base station 31 indicate that the communication is finished through the FACH channel.

FIG. 9 shows equalisation means used in the terminal 32 according to one variant embodiment of the invention that is particularly suitable when the transmission channel is very noisy and/or disturbed (for example by a strong Doppler type effect or an environment with multiple echoes that cause signal fading, that is difficult to process when the OFDM signal does not have a pilot symbol according to some embodiments of the invention).

According to the state of the art, for such a channel, those skilled in the art would not only insert symbols for example comprising 10% of sub-carriers associated with pilots (as shown in FIG. 1) into the OFDM signal, but also a training sequence that only includes pilot type sub-carriers. These symbols not containing any data account for several percent (for example 10%) of OFDM symbols and correspondingly reduce the available pass band that can be used for the data.

According to the variant of the invention shown with reference to FIG. 9, a transmitter transmits a CPICH signal continuously and data using an OFDM modulation to a receiver using equalisation means 90. According to this variant, some OFDM symbols include pilots to make a frequency estimate. The equalisation means 90 make firstly a frequency estimate from the CPICH channel in order to fix the frequency of the reference clock (clock at 13 MHz also called VTCXO and in particular conforming with the GSM and UMTS standards (particularly the standard reference TS 25.101) defined by the 3GPP (3rd Generation Project Partnership) standardisation committee, from the receiver to the transmitter. The reference clock of the receiver is not the same as the reference clock of the transmitter. There are also drifts in the frequency of this clock, usually due to a Doppler effect or a drift of the reference clocks (usually mobile terminal clocks). Equalisation means 90 also demodulate the OFDM signal and equalise it taking account of the frequency estimate made from the CPICH channel.

The equalisation means 90 comprise:
a CPICH input accepting base band signals modulated in single-carrier and output by the DSP 518;
an OFDM input accepting base band signals modulated in multiple-carrier (OFDM type) and output by the DSP 518.

In particular, the CPICH input includes a CPICH type signal used to estimate the reference frequency.

The equalisation means 90 also include:
frequency estimating means 91 designed to estimate the frequency corresponding to signals received from a single-carrier pilot signal;
   an oscillator 97;
   a frequency synthesiser 98;
   channel estimating means 96;
   OFDM demodulation means 93; and
   an OFDM equalisation unit 95.

The means 91 accept a CPICH type single-carrier signal as input. They make a non-coherent demodulation of the CPICH signal particularly including auto-correlation (descrambling) of the CPICH signal supplying a time estimate of CPICH symbols from which the phase between two successive symbols in the CPICH signal is calculated (particularly using a rake receiver, a weighted sum and integration with a first order filter to correct excessively strong fluctuations). The means 91 thus output a signal used to pilot slaving of the oscillator 97 that generates a reference clock at 13 MHz associated with signals received in the entire receiver.

The frequency synthesiser 98 generates a digital clock CLK 92 derived from the reference clock and transmits this clock 92 to the different parts of the equalisation means 90.

According to the variant shown in FIG. 9, there is no need for the OFDM symbols to be transmitted synchronously with the CPICH symbols. Only the transmission frequencies of the OFDM and CPICH signals are derived from the same reference clock (since the RF carriers are not necessarily the same).

The result is thus a frequency or reference clock CLK 92 used for the OFDM equalisation and output by the means 90 to the other parts of the transmitter/receiver, particularly frequency estimating means 91, channel estimating means 96, OFDM demodulation means 93 and the OFDM equalisation unit 95. The result is slaving in a closed loop.

The means 93 demodulate the OFDM signal in input using the reference clock 92 and output demodulated OFDM symbols to the OFDM equalisation unit 95.

The channel estimating means 96 take account of symbols demodulated by the means 93 and the reference clock 92 to provide amplitude and phase corrections for the equalisation means 95 determined from the OFDM signal.

The equalisation unit 95 receives the clock 92, a channel estimate and demodulated OFDM symbols 94 simultaneously, communicated by means 91, 96 and 93 respectively. The unit 95 equalises the OFDM symbols starting from a reference clock 92 and as a function of a time estimate of the channel associated with the OFDM symbols and then outputs information data corresponding to the processed OFDM symbols on the output 55.

In the receiver, the equalisation means 90 are used in the transmission-reception module 50:
either instead of equalisation means 519 shown above for this relatively simple implementation that is particularly suitable for any channel type (with high or low noise);
or combined with the means 519.

A receiver combining the means 90 and the means 519 is particularly suitable for optimisation of the useful pass band regardless of channel disturbances. Such a receiver and the corresponding transmitter preferably use dynamic management of the change over between processing of the OFDM signal with or without pilots; when the channel is very noisy, the OFDM signal comprises pilots and the receiver uses the CPICH channel for an estimate of the reference frequency and the OFDM channel for a time estimate of the channel with the use of means similar to means 90; on the other hand, when the channel is not very noisy, the transmitter sends an OFDM signal without pilot and the receiver using means similar to means 519 estimates the channel starting from the CPICH signal to equalise the OFDM signal. The transmitter and/or the receiver then comprise means of identifying a good or bad reception when the OFDM signal does not have a pilot or more generally means to identify the transmission mode best adapted to the channel possibly taking account of the required quality of service (for example pass band needs; since the best pass band occurs when there is no pilot, the without pilot mode will be preferred when pass band needs are high). The transmitter and the receiver agree to the transmission mode, for example through the RACH and FACH channels in a manner similar to that described above with reference to FIG. 8 and the transmitter and the receiver use means of processing different communication modes (without OFDM pilot or with more or less OFDM pilots).

By default, the base station preferably uses an OFDM modulation without pilot according to a first communication mode. If the reception quality is not sufficient for the terminal 32 to demodulate and equalise the OFDM signal with a channel estimate based on the CPICH channel, the base station changes over to a second communication mode. In the second communication mode, some OFDM symbols comprise pilots for making a frequency estimate and the equalisation means 90 make a frequency estimate starting from the CPICH channel used to fix the frequency of the reference clock as indicated above with reference to FIG. 9. Obviously, if the reception quality improves (particularly due to a reduction in noise or an increase in the power of the received signal so that the signal to noise ratio can be reduced), the base station changes over to the first communication mode so as to optimise the useful throughput.

Two cases can arise in a network in which a base station (transmitter) communicates with several terminals (receivers):
according to a first case, communications are multiplexed in time (for example using a TDMA (Time Division Multiple Access) protocol); at any given time, only one radio link is active and the data are transmitted according to an OFDM modulation in the first or second mode as a function of the corresponding receiver;
according to a second case, communications are multiplexed in frequency (for example using the FDMA (Frequency Division Multiple Access) protocol) and possibly in time; several radio links can then be active simultaneously; at any one time, since the OFDM pilots use the entire frequency band allocated according to the second mode, all OFDM communications use the same mode with pilot (second mode) or without pilot (first mode); for each time interval allocated to one or several receivers, the base station determines the most appropriate communication mode using any criterion (for example the reception quality of at least n terminals is insufficient to enable them to demodulate and equalise the received OFDM signal with a channel estimate based on the CPICH channel; n is a threshold parameter and may for example be equal to 1 or any another predetermined or dynamically updated value (depending in particular on the number of terminals).

Furthermore, the network according to the invention, which in particularly implements the first and second modes (or one of the two) is designed to cohabit with a network that does not use a CPICH type channel and particularly with a base station designed to communicate in a third mode in which the OFDM symbols contain more pilots (for example according to the third communication mode, a known state of the art modulation is used in which 90% of OFDM symbols contain 10% of the sub-carriers associated with pilots, and also a training sequence including only pilot type sub-carriers).

Obviously, the invention is not limited to the example embodiments mentioned above.

In particular those skilled in the art could introduce any variant into the definition of single-carrier and multiple-carrier modulations used. In particular, the single-carrier modulation could be a phase modulation type (for example PSK (Phase Shift Keying), or GMSK (Gaussian Minimum Shift Keying) or an amplitude modulation type (particularly FDK (Frequency Shift Keying), or QAM (Quadrature Amplitude Modulation)). Similarly, those skilled in the art could make any variant in the type of multiple-carrier modulation used. Thus, the modulation could be for example of the OFDM type as described particularly in patent FR-98 04883 filed on Apr. 10, 1998 by the Wavecom Company or an IOTA type modulation as defined in patent FR-95 05455 filed on May 2, 1995 and included herein by reference.

The invention is not limited to UMTS or 3G networks, but includes communications between a fixed or mobile transmitter and a fixed or mobile receiver (for example corresponding to two terminals, a network infrastructure station and a terminal, or two network infrastructure stations), particularly when high spectral efficiency and/or saving of the pass band are desired. Thus, for example, possible MEDIUM for the invention include terrestrial digital radio broadcasting systems of images, sound and/or data, broadband digital communication systems to mobiles (in mobile networks, radio LANs or for transmissions to or from satellites), and submarine transmissions using an acoustic transmission channel.

There are many applications of the invention and they can be used particularly for internet type broadband services (if the invention is applied to UMTS, the low speed of the RACH channel, although much higher than GSM coupled with the very high speed of the OFDM channel, satisfies the needs of such services).

Apart from the channel estimate, the invention enables use of the single-carrier channel to perform processing specific to the OFDM channel, and particularly initial synchronisation and monitoring of synchronisation in time or frequency, measurement of the quality of the channel and adaptation of modulation, etc.

1. Method for radio data transmission between a transmitter and a receiver using at least one single-carrier pilot signal and at least one first transmission signal for data transmitted using a multiple-carrier modulation,
wherein the said method comprises a step to estimate the response of the transmission channel for the first transmission signal for data transmitted using a multiple-carrier modulation, the said estimate taking account of the single-carrier pilot signal, at least part of the said pilot signal being coincident in time with at least part of the said first signal.

2. Method according to claim 1, wherein the part of the said pilot signal taken into account by the said estimate coincides entirely with at least part of the first signal.

3. Method according to claim 1, wherein the said pilot signal and the said first signal are asynchronous.

4. Method according to claim 1, wherein the said pilot signal and the said first signal are synchronous.

5. Method according to claim 1, wherein the frequency band used for the said pilot signal on a transmission channel encompasses the frequency band used for the said first transmission signal.

6. Method according to claim 1, and further comprising equalization of the said data transmitted according to a multiple-carrier modulation, the said equalization taking account of the said estimated response of the transmission channel used for the said first transmission signal.

7. Method according to claim 1, wherein the said estimate takes account of at least one auto-correlation made on the said pilot signal.

8. Method according to claim 7, wherein each of the said auto-correlations is associated with a delay corresponding to a path on the said transmission channel.

9. Method according to claim 8, wherein the said auto-correlations are made for each path between the said transmitter and the said receiver on the said transmission channel and corresponding to delays of less than a determined maximum limit.

10. Method according to claim 8, and further comprising a step to select paths between the said transmitter and the said receiver on the said transmission channel, and in that the said auto-correlations are made for each path selected during the said selection step.

11. Method according to claim 7, and further comprising a step to determine a frequency response taking account of the said auto-correlations.

12. Method according to claim 11, and further comprising a Fourier transform step supplying at least one coefficient associated with each sub-carrier of a symbol of the said first transmission signal for data transmitted using a multiple-carrier modulation.

13. Method according to claim 1, wherein the said pilot signal is of the spectrum spreading type.

14. Method according to claim 1, wherein the said first transmission signal is of the OFDM type.

15. Method according to claim 1, wherein the said first transmission signal is of the IOTA type.

16. Method according to claim 1, wherein the said transmitter also transmits a second data transmission signal to the receiver on a single-carrier channel, the said signal being equalized from a channel estimate determined as a function of the said pilot signal.

17. Method according to claim 1, wherein the said transmitter and the said receiver belong to a mobile communication network.

18. Method according to claim 17, wherein the said transmitter belongs to a base station in the said mobile communication network and the said receiver belongs to a terminal, the said base station sending the said pilot signal and the said first data transmission signal using a multiple-carrier and high speed modulation whenever necessary.

19. Method according to claim 1, wherein the said first transmission signal for data transmitted using a multiple-carrier modulation does not include a pilot symbol.

20. Method according to claim 1, and further comprising a step (98) to generate a reference clock associated with the said first transmission signal for data transmitted using a multiple-carrier modulation, the said generation of a reference clock taking account of the said single-carrier pilot signal, and the said reference clock outputting the said estimate of the response of the transmission channel for the said first transmission signal for data transmitted using a multiple-carrier modulation.

21. Method according to claim 20, and further comprising equalization of the said data transmitted using a multiple-carrier modulation, the said first transmission signal for data transmitted using a multiple-carrier modulation comprising pilot symbols and the said reference clock outputting the said equalization.

22. Method according to claim 1, and further comprising using at least two transmission modes for data transmitted using a multiple-carrier modulation, the said first transmission signal for data transmitted using a multiple-carrier modulation comprising pilot symbols according to a first mode and not including pilot symbols according to a second mode.

23. Method according to claim 22, and further comprising a step to change over from the said first mode to the said second mode and vice versa as a function of the reception quality of the said first transmission signal for data transmitted using a multiple-carrier modulation.

24. Radio data reception device comprising at least one single-carrier pilot signal and at least one transmission signal for data transmitted using a multiple-carrier modulation,
wherein the said device comprises means for estimating the response of the transmission channel for the said transmission signal for data transmitted using a multiple-carrier modulation, the said estimate taking account of the said single-carrier pilot signal, and at least part of the pilot signal being coincident in time with at least part of the first signal.

25. Radio data transmission device comprising at least one single-carrier pilot signal and at least one transmission signal for data transmitted using a multiple-carrier modulation,
wherein the said device comprises modulation means for the said transmission signal with no pilot, the said pilot signal being designed to enable an estimate of the response of the transmission channel for the said transmission signal for data transmitted using a multiple-carrier modulation, the said estimate taking account of the said single-carrier pilot signal, and at least part of the pilot signal being coincident in time with at least part of the first signal.

26. Radio data transmission signal carried on at least one single-carrier pilot channel and one multiple-carrier data transmission channel wherein the said multiple-carrier data transmission channel has no pilot, the said single-carrier pilot channel being designed to enable an estimate of the response of the transmission channel for data transmitted using a multiple-carrier modulation, the said estimate taking account of the said single-carrier pilot signal, and at least part of the pilot signal being coincident in time with at least part of the first signal.

27. Cell type telecommunication system comprising at least one single-carrier pilot channel and one multiple-carrier data transmission channel wherein the said multiple-carrier data transmission channel has no pilot, the said single-carrier pilot channel being intended to enable an estimate of the response of the transmission channel for data transmitted using a multiple-carrier modulation, the said estimate taking account of the single-carrier pilot signal, and at least part of the pilot signal being coincident in time with at least part of the first signal.
